(19) United States
(12) Patent Application Publication
(10) Pub. No.: US 2025/0273357 A1
(43) Pub. Date: Aug. 28, 2025

(54) Monolithic Spring Contact for a Trap for Charged Particles

(71) Applicant: Alpine Quantum Technologies GmbH, Innsbruck (AT)

(72) Inventors: Georg Jacob, Innsbruck (AT); Alexander Erhard, Innsbruck (AT); Philip Holz, Innsbruck (AT)

(21) Appl. No.: 19/059,417

(22) Filed: Feb. 21, 2025

(30) Foreign Application Priority Data
Feb. 22, 2024 (EP) 24159169.2

(51) Int. Cl. G21K 1/00; H01R 4/48

(52) U.S. Cl. CPC G21K 1/00; H01R 4/48

(57) ABSTRACT

The present disclosure relates to a module of a trap for charged particles (e.g., ions), to manufacturing such module, to a trap including the module and a manufacturing of such modular trap. The module includes a monolithic body made of a non-conductive substrate and an electrode arranged on a portion of a surface of the monolithic body. A part of the monolithic body forms a spring element. An electrically conductive area is arranged on and covers a portion of a surface of the spring element and is conductively connected with the electrode. The spring element is adapted to compress upon pressure applied on the electrically conductive area.

### CROSS-REFERENCE TO RELATED APPLICATION

This application claims priority to European Patent Application No. 24159169.2 filed Feb. 22, 2024, the disclosure of which is hereby incorporated by reference in its entirety.

### BACKGROUND

### Technical Field

The present disclosure relates to modules for producing traps for charged particles and to a method manufacturing such modules.

### Technical Considerations

An ion trap or in general a trap for trapping charged particles (referred to in the following as “trap”) is typically electrically connected or connectable to other external devices or systems. Moreover, it may be desirable to electrically connect different parts of a trap as required. Both goals are typically achieved by using wire-bonding, soldering, pogo-pins, elastomeric connectors, fuzz buttons or metallic springs, or the like.

For example, for ion traps that are made and manufactured from a nonconductive bulk material which is metalized to define the spatial structure of its electrodes, adding such connections may complicate a manufacturing process. For example, the manufacturing process may require more steps which may result in longer a production time and in an additional source of defects of the products.

Thus, it would be desirable to design a simpler trap and a corresponding manufacturing process.

### SUMMARY

The present disclosure facilitates provision of electrical connections on a trap module. For example, a module of a trap for charged particles (e.g., ions) is provided, a method for manufacturing such module, a trap including the module and a manufacturing of such modular trap. The trap module comprises a monolithic body made of a non-conductive substrate and an electrode arranged on a portion of a surface of the monolithic body. A part of the monolithic body forms a spring element. An electrically conductive area is arranged on and covers a portion of a surface of the spring element and is conductively connected with the electrode. The spring element is adapted to compress upon pressure applied on the electrically conductive area.

These and other features and characteristics of the presently disclosed subject matter, as well as the methods of operation and functions of the related elements of structures and the combination of parts and economies of manufacture, will become more apparent upon consideration of the present disclosure with reference to the accompanying drawings, all of which form a part of this specification. It is to be expressly understood, however, that the drawings are for the purpose of illustration and description only and are not intended as a definition of the limits of the disclosed subject matter. As used in the specification and the claims, the singular form of “a,” “an,” and “the” comprise plural referents unless the context clearly dictates otherwise.

### BRIEF DESCRIPTION OF THE DRAWINGS

An understanding of the nature and advantages of various embodiments may be realized by reference to the following figures.

The terms Fig., Figs., Figure, and Figures are used interchangeably in the specification to refer to the corresponding figures in the drawings.

FIG. 1(a) is a cross-section drawing illustrating an exemplary spring construction showing an expanded or uncompressed spring.

FIG. 1(b) is a cross-section drawing illustrating an exemplary spring construction showing a compressed spring.

FIG. 1(c) is a cross-section drawing illustrating an exemplary spring construction.

FIG. 2(a) is a cross-section drawing illustrating another exemplary spring construction showing an expanded or uncompressed spring.

FIG. 2(b) is a cross-section drawing illustrating another exemplary spring construction showing a compressed spring.

FIG. 2(c) is a cross-section drawing illustrating another exemplary spring construction.

FIG. 3 is a schematic drawing of electrode portion of an exemplary ion trap and a trapping zone.

FIG. 4 is a schematic drawing of exemplary electrically conducting interfaces between trap modules and towards external devices.

FIG. 5 is a schematic drawing of other exemplary electrically conducting interfaces between trap modules and towards external devices.

FIG. 6 is a schematic drawing illustrating an electrically conducting interface for joining a trap to an external substrate, for instance a chip.

FIG. 7 is a schematic drawing illustrating n trap modules that are connectable to each other in a cascade to form a modular trap for charged particles such as ions.

FIG. 8 is a flow diagram illustrating an exemplary manufacturing method for manufacturing a trap module.

FIG. 9 is a flow diagram illustrating an exemplary manufacturing method for manufacturing a trap.

FIG. 10 is a drawing of an exemplary cantilever spring in an oblique view.

FIG. 11 is a drawing of the exemplary cantilever spring of FIG. 10 in a side cross section view.

FIG. 12 is a drawing of the exemplary cantilever spring of FIG. 10 in a top view.

FIG. 13 is a drawing of an exemplary helix spring in an oblique view.

FIG. 14 is a drawing of the exemplary cantilever spring of FIG. 13 in a side cross section view.

FIG. 15 is a drawing of the exemplary cantilever spring of FIG. 13 in a side view.

Like reference numbers and symbols in the various figures indicate like elements, in accordance with certain example implementations.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to comprise one or more items and may be used interchangeably with “one or more” and “at least one.” Furthermore, as used herein, the term “set” is intended to comprise one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” “including” or the like are intended to be open-ended terms. Further, the phrase “based on” is intended to mean “based at least partially on” unless explicitly stated otherwise.

With a trap that is made from a nonconductive bulk material which is metalized to form and define a spatial structure of its electrodes, typically additional parts or processes have to be used to provide an electrical connection to an electrical interface outside of the trap, e.g., to a chip-carrier or to a socket, and/or to provide an electrical connection between the parts of a trap that are composed of more than one part. When referring herein to “conductive” material, what is meant is electrical conductivity.

According to some non-limiting embodiments, a module of a trap is provided. The module comprises a monolithic body made of a non-conductive substrate and an electrode arranged on and covering a portion of a surface of the monolithic body.

A trap is a trap for charged particles such as a trap for ions. However, the present disclosure is not limited thereto and the trap may be a trap for protons, electrons or the like. When referring to a non-conductive material, such material is not necessarily a dielectric (electric insulator); it may be for instance a semiconductor.

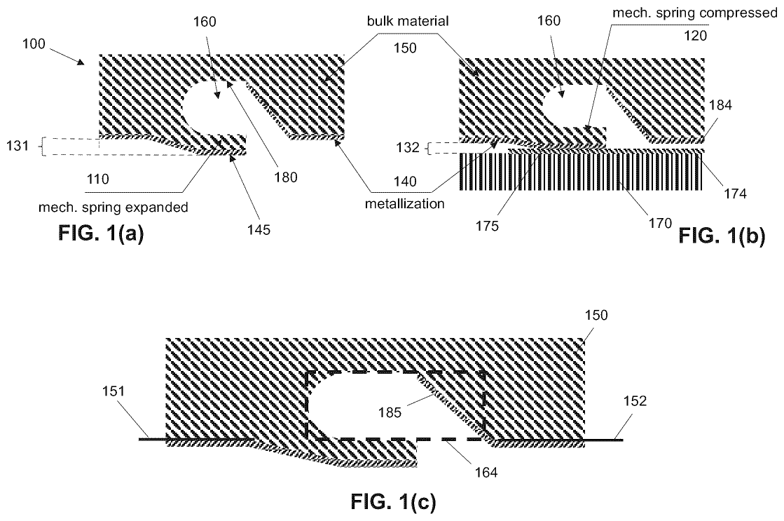

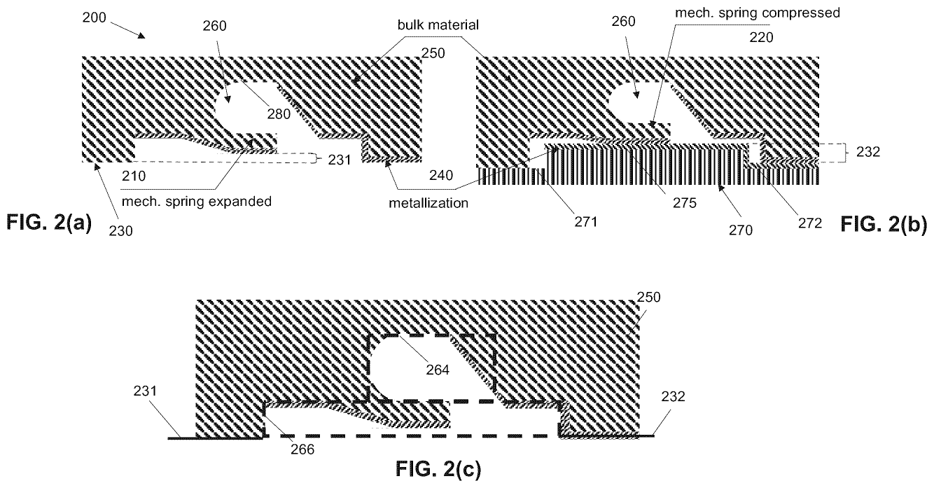

FIG. 1(a) illustrates a portion 100 of a non-limiting example of a trap module. A part 150 of the monolithic body forms a spring element 110 (also referred to herein as “spring”). The spring element 110 is an elastic element, which may compress (constrict) when in contact with (under pressure of) an external object, such as external module 170. The spring 110 may decompress back when there is no contact (pressure) from the external object.

An electrically conductive area 145 is arranged on, and covers a portion of a surface of the spring element 110 and is conductively connected with the electrode. The conductive connection to the electrode may be metalized 140 on the surface of the monolithic material 150 of the trap module. However, the present disclosure is not limited to such connection. In addition or alternatively, the conductive connection may lead through the monolithic material 150. In FIG. 1(a), in some non-limiting examples, the electrically conductive area 145 of the spring 110 is a metalized portion fixed on the monolithic material 150 of the trap module that forms a surface portion of the spring 110. The fixing may be achieved by, for example, depositing, coating, gluing, etching or any other techniques known in the art comprising provision of an adhesive layer between the monolithic material and the conductive layer. As shown in FIG. 1(b), the spring element is compressed 120 when a pressure is applied to the electrically conductive area 145, so as to form a stable electrical connection with the external module 170. This may be achieved by applying pressure to contact the conductive area 145 of the spring 110 with a conductive area 175 of the external module 170. The external module 170 here is, in some non-limiting embodiments, another module of the same trap or another, external device such as a socket or a chip or a substrate or the like. The external module 170 may comprise an electrically conductive port comprising the conductive area 175. The port may be adapted to receive or engage with the conductive area 145 of the spring of the trap module. It is noted that the ion trap may be constructed as one monolithic trap module or by combining one or more monolithic trap modules.

FIG. 1(a) further shows in some non-limiting embodiments the non-conductive material (bulk material in this example) 150 of the trap module and a recess 160 formed therein. FIG. 1(a) shows the spring 110 uncompressed and FIG. 1(b) shows the spring 110 compressed and in contact with the external module 170. FIG. 1(c) illustrates the recess. The compression of the spring may be achieved by force applied to connect the external module 170 and the trap module (portion) 100. The present disclosure is not limited to any specific way in which the force is generated. For example, the force may be applied by an additional joining means joining the external module 170 and the trap module 100. Such joining means may be, for example, one or more screw(s), bolt(s), clamp(s) or the like. Some further possible joining means comprise a snapping mechanism, adhesive layer (e.g., glue), or any other state of the art mechanic connection. In general, such connection may be attachable and detachable (enabling for reuse of the modules in other assemblies), or it may be fixed.

In FIG. 1(a), in some non-limiting embodiments, the spring element 110 is a cantilever. As is shown in FIG. 1(c), the cantilever may be formed by extending a portion of a flat surface 151 of the monolithic body 150 over a surface 180 of the monolithic material 150. In FIG. 1(c), the cantilever 110 extends over a recess 160 in the surface 151-152 of the monolithic body 150. However, it is noted that this is only an example, which may provide an advantage of an efficient production. However, the present disclosure is not limited thereto. In general, the cantilever may protrude from the surface 151 of the monolithic body 150 without a recess. Moreover, the spring element 110 does not necessarily need to be a cantilever, but may have any form that enables compression/decompression upon and applying pressure externally on the conductive portion 145. For example, the spring may have a spiral form or any other compressible and de-compressible form formed out of the material 150 of the monolithic body and forming a part of the monolithic body.

For example, in FIG. 1(a), in one non-limiting possible construction, the spring element 110 protrudes over a flat surface 151 of the monolithic body 150 in which the spring element 110 is formed and is adapted to reduce the protrusion 131 when the pressure is applied to the electrically conductive area 145 of the spring 110. In FIG. 1(b), the compressed spring element 110 still protrudes over the surface 151 monolithic body so that the conductive area 145 of the spring 110 forms an extremity of the trap module (e.g., includes a highest portion on the monolith relative to the surface 151 from which the spring 110 is extending). For example, the protrusion 131 is reduced to a smaller protrusion 132 in this example. However, the present disclosure is not limited to reducing the protrusion to a smaller protrusion. The reduction may lead to flattening the protrusion 131 to the level of the flat surface 151 and/or 152 or even to push the spring element 110 below the flat surface 151 and/or 152 of the monolithic body 150.

In FIG. 1(c), in some non-liming embodiments a specific formation of the spring 110 is illustrated. For example, the monolithic material 150 has a first flat surface portion 151, which extends as an outer (upper, facing outward the monolith) part of the cantilever forming the spring 110. In the monolithic material 150, a recess 160 is formed which is denoted by a rectangle 164, but the recess 160 can have any shape. This exemplary recess is a cavity formed in the monolithic material by an inner (lower, facing inward the monolith) part of the cantilever and a hollow portion below the cantilever. In this example, the cantilever extends towards, but does not touch a second flat surface 152 of the monolith 150, which is in a similar plane as the first flat surface 152. However, in general, the surfaces 151 and 152 need not be on the same plane. In FIG. 1(c), in some non-liming embodiments a portion 185 of the cavity surface facing the cantilever is also covered by a conductive layer which continues on the second surface 152. This may result from a specific configuration of a metallization process and is, in general, not necessary for the functionality of the trap. Moreover, the second flat surface 152 may be covered by a conductive layer 184, which may have a counterpart 174 conductive layer on the external surface 170 (shown in FIG. 1(b)). However, this additional conductive connection does not need to be present for functional purposes. It may result from a metallization/coating process in which the entire surface is coated unless masked/covered. Such process may have a lower complexity and may be more robust against inaccuracies.

FIG. 2(a) illustrates another non-limiting possible construction of the trap module portion 200 including a spring element 210. As can be seen, the construction of FIG. 2(a) corresponds generally to construction of FIG. 1(a) set within a connection recess 266 (see (c) FIG. 2(c)). In this construction, the spring element 210 does not protrude over a flat surface 230 of the monolithic body 250. Rather, the spring element 210 is embedded within the connection recess 266, so that all parts of the spring element 210 are located below 231 the flat surface 230 when uncompressed, as can be seen in FIG. 2(a). In this example, when the spring element 210 is compressed (shown in FIG. 2(b)), it is still located below 232 the flat surface 230-and even more below than in case of the uncompressed spring 210. An external module 270 pressing on the conductive area of the spring 210 causes the compression of the string 210. In this example, the external module 270 includes a flat portion 271 and 272 and a protruding portion 275.

It is noted that provision of the spring 110, 210 at least partly within the recess 180, 280 may provide an advantage of a higher mechanical robustness. For example, it may protect the spring from (or reduce a probability of) being ripped off. Moreover, the recess 180, 280 may provide means to mechanically align the trap module with respect to another trap module or an external module or the like.

The protruding portion 275 has a height and shape that fits into the connection recess 266. In other words, the rectangular portion 275 has a form that is formed (adapted) be accommodated within the also rectangular connection recess 266. However, the cross-section of the connection recess 266 and/or the protruding portion 275 do not need to be rectangular and may include or be rounded or have any other shape.

Similarly to FIG. 1(c), FIG. 2(c) further shows that the monolithic body 250 is metalized 240. The spring 210 in this example is also a cantilever extending over a spring recess 260, which may be a cavity (hollow space) formed in the monolithic material 250. Moreover, the second flat portion 272 of the external module 270 in FIG. 2(b) is covered by a conductive layer and so is the second flat portion 232 of the monolithic material 250. The trap portion may engage with the external module 270 by stacking the second flat portion 232 of the trap onto the second flat portion 272 of the external module 270 (in a case these are covered by a conductive material, a conductive connection may be established between them). Thereby the protruding portion 275 (covered by conductive material at least partially) of the external module 270 applies pressure onto the conductive area of the spring 220 so that the spring 220 is compressed and a conductive connection is formed.

It is noted that FIGS. 1(a)-(c) and 2(a)-(c) show merely examples of a string construction that do not limit the present disclosure. Any elastic element formed out of the monolith of the trap module with the conductive area may be provided such that a pressure on the conductive area causes string compression.

For example, in both FIG. 1(a) and FIG. 2(a), the electrically conductive area is located on an outer surface of the spring element facing away from the module of an ion trap. While this feature may facilitate production and for example fixing of the conductive layer onto the monolithic material, it is conceivable to provide conductive area on an inner surface of the spring and/or on the surface 180, 280 of the cavity instead. An external module may then be accommodated into the cavity 180 so as to apply pressure onto the inner part of the spring 110, 210, thereby compressing it in the outward direction (facing away from the trap). In addition to the properties useful for ion traps, a certain tensile strength may be desirable in order to produce a spring which is small enough that may facilitate integration/miniaturisation. For example, for the material fused silica, Young's modulus is 72.5 GPa and it has a typical tensile strength of 50 MPa. For small dimensions (as specified here), a production process that leads to a small amount of surface flaws, tensile strength of up to 10 GPa has been observed. However, it is noticed that these are only exemplary values which may vary as is clear to a person skilled in the art.

In some non-limiting embodiments, the non-conductive substrate (monolithic material 150, 250) is made of glass, fused silica, sapphire, diamond, silicon, ceramic and/or the like. In general, a desirable feature of the material forming the monolith 150, 250 may be a certain tensile strength in order to produce a spring, which is small enough (depending on requirements of the implementation).

For example, if a force of 0.04 N was applied to a spring made out of fused silica with the following dimensions, thickness of lever 15 μm, length of lever 250 μm and width of lever 100 μm, the maximum elongation would be 60 μm at a maximum stress of 1 GPa. The spring constant is around 1 N/mm. It should be noted, that the metallization of the cantilever can alter the mechanical properties. As is clear to those skilled in the art, these values are only exemplary. Different materials and target values may be employed to produce a functional spring.

It is noted that in general multi-metal layer structures may be used for the coating. For instance, some layer(s) may be used as bonding layer; some may be used as a diffusion barrier, or the like. When designing the spring, the layers can be taken into account together with the actual monolithic material (and the contact metal layer).

The conducting material that covers portion of the surface of the trap may be any conductive material such as gold, silver, platinum, copper, niobium, aluminum, various alloys or the like. Generally, it may be desirable to provide a conducting material that is corrosion resistant.

In some non-limiting embodiments, the trap module may be a complete trap body including electrodes, or it may be merely a part of a trap including a portion of the trap body and at least one electrode for producing a trapping zone.

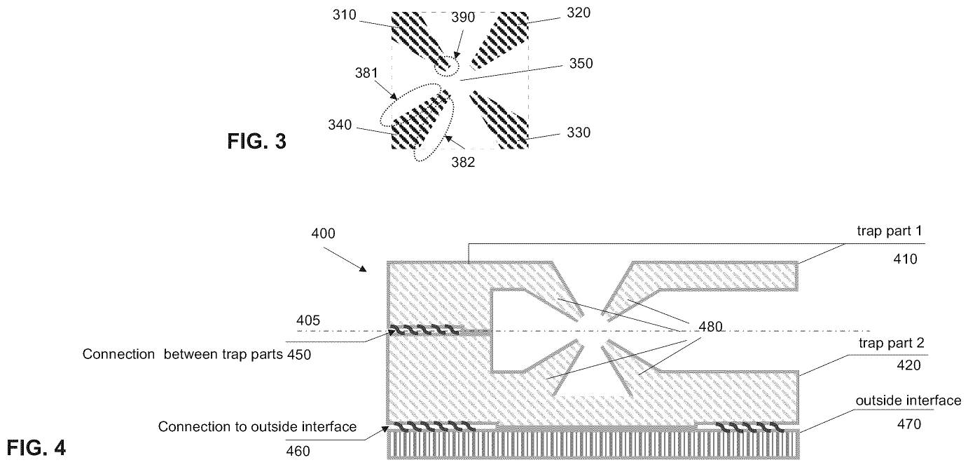

For example, the trap module may be (a part of) an ion trap which is a Paul trap. A schematic example of Paul trap components is shown in FIG. 3. FIG. 3 illustrates four portions 310, 320, 330, and 340 of the trap body arranged regularly around the trapping zone 350. The trap body portions may carry electrodes. For example, a peak 390 (indicated by a dotted circle) of the body portion 310 may be coated by a conductive material forming an electrode. Similar peak electrodes may be provided on the remaining three trap body portions 320, 330, and 340. It is noted that one or more of the body portions 310, 320, 330, and 340 may carry side electrodes on their one or both sides indicated by respective dotted circles 381 and 382. The body portions 310, 320, 330, and 340 may be held in place by any means, for instance a common monolithic frame or a frame made up of modules joined together.

In general, a trap module may include an arrangement or a part of the arrangement of direct current, DC, and radio frequency, RF, electrodes for trapping of charged particles in the trapping zone 390. It is noted that FIG. 3 illustrates a 3-dimensional (3D) Paul trap for charged particles. However, the present disclosure is not limited thereto. The trap for charged particles may be a surface trap or another kind of trap.

The trap module with a spring formed out of a monolithic material as described with reference to FIGS. 1(a)-(c) and 2(a)-(c) may be a trap module that is a basic block of a trap. A trap may then be constructed by cascading two or more such trap modules. In order to provide a possibility of cascading two or more trap modules, it may be advantageous for a trap module as described below to further comprise a pressure element (such as the protruding portion 275) with an electrically conducting surface and conductively connected to an electrode or to a ground or the like. The trap module is then a first module of a complete trap. The first module is also adapted to be mechanically joined with a second module of the ion trap which may be of a similar construction as the first module (including the pressure element). This enables provision of a single type of trap module and obtaining a trap by cascading a plurality of trap modules of the single type. However, the present disclosure is not limited thereto. The second trap module may be a trap module as described with reference to FIGS. 1(a)-(c) or FIGS. 2(a)-(c) (not necessarily comprising the pressure element). In general, the pressure element of the first module of the ion trap conductively connects with the spring element of the second module of the ion trap.

FIG. 4 illustrates a non-limiting example of an ion trap 400 formed by two trap modules: a first trap module (trap part 1) 410 and a second trap module (trap part 2) 420. The two trap modules 410 and 420 are conductively connected via a connection portion 450. A dash-dotted line 405 indicates separation of the first trap module 410 and the second 420 trap module. As can be seen in this exemplary illustration, each trap module (410, 420) includes two electrode body portions 480. After connecting the trap modules, the ion trap 400 is obtained which is a Paul trap.

In FIG. 4, the first trap module 410 (above the line 405) and the second trap module 420 (below the like 405) differ in construction. However, as noted above, the two trap modules could also have the same construction, e.g., the construction as the second trap module 420 (in case a connection by a spring to a trap-external module 470 is desired) or the construction as the first trap module 410.

The trap 400 may be an ion trap or generally a trap for trapping charged particles that comprises the first module 410 of the trap that is the module as shown in or discussed with reference to FIGS. 1(a)-(c) or 2(a)-(c). The trap 400 further comprises the second module 420 of the ion trap adapted to be mechanically joined (cf. connection part 450) with the first module 410 of the ion trap. The second module 420 comprises 1) an electrode arranged on and covering a portion of a surface of the second ion trap module (can be monolithic); and 2) a pressure element with an electrically conducting surface and conductively connected to the electrode.

The (one or more) electrode(s) may be covering peak and/or sides of the electrode body 480. The pressure element may be similar to protrusion 275 of FIG. 2(b) or just a surface to put pressure on the spring 110, 210 of the first module. The first module 410 of the ion trap 400 and the second module 420 of the ion trap 400 may be mechanically joined and, thereby, the pressure element of the second module 420 of the ion trap 400 applies pressure on the electrically conductive area (not shown in FIG. 4) of the first module 410 of the ion trap. Accordingly, the electrode of the first module 410 electrically connects with the electrode of the second module 420. For instance, two or more electrodes of the trap modules are connected, e.g., to a port for connecting to an RF or a DC driving source or directly to the RF or DC driving source.

The second trap module shown in FIG. 4 (trap part 2) comprises connection means (interface) 460 for connecting with an external module 470 (in general, external or outer interface). The external module 470 may be any external object to which the trap 400 is to be conductively connected.

For example, a trap assembly is provided comprising at least one module of a trap as described with reference to FIGS. 1(a)-(c) and 2(a)-(c) (or a trap module that is a trap, the body of which is made of one piece). The trap assembly also includes a chip carrier or a socket for mounting the module of an ion trap, adapted to be mechanically joined (e.g., by the connection interface 460) with (the module of) the trap and comprising a pressure element with an electrically conducting surface. The chip carrier or the socket may correspond, for example, to the external module 470 of FIG. 4. In the assembly, (the module of) the trap and the chip carrier or a socket are mechanically joined and, thereby, the pressure element applies pressure on the electrically conductive area of the trap module. Thereby, one or more electrodes of the trap (module) 400 is electrically connected with the chip/socket 470.

It is noted that FIG. 4 shows two trap modules 410 and 420, each trap module includes two electrodes. However, the present disclosure is not limited thereto. Another kind of modularity can be provided. For example, each trap module can have a single electrode; or each module can have a half of each of two electrodes; or the like. It may be advantageous to provide trap modules that have the same construction (form, size). In this way, the manufacturing may be facilitated. Nevertheless, it is conceivable that the trap modules may have respective different number of electrodes contained.

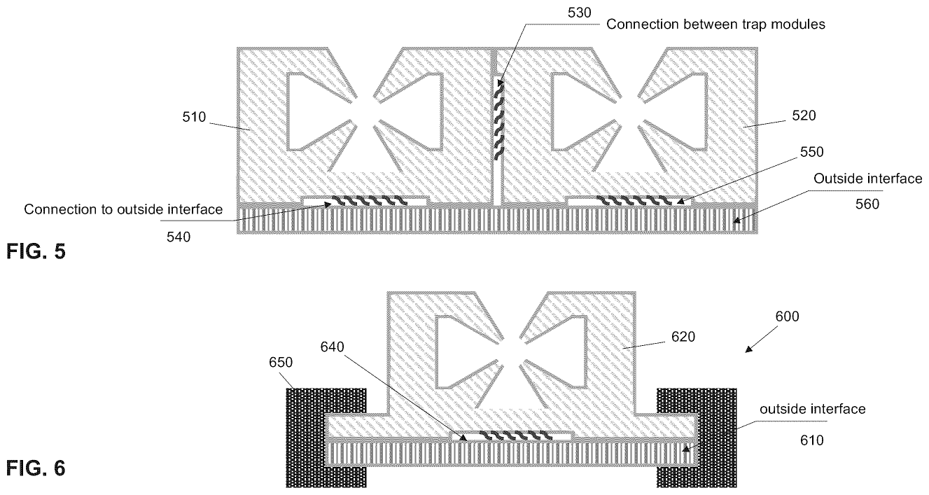

FIG. 5 shows schematically another non-limiting example of two trap modules 510 and 520. In this example, each trap module 510 and 520 alone is a trap including four electrode bodies with one or more electrodes as shown in FIG. 3. In other words, each trap module 510 and 520 is capable of trapping ions when driven appropriately, i.e., each trap module has its trapping zone. The two trap modules 510 and 520 are connected using the connection portion 530. The connection portion 530 may correspond in one module to a spring such as in FIGS. 1(a)-(c) or 2(a)-(c) and in the other module to a pressure means for applying pressure in the spring. While FIG. 5 shows two trap modules 510 and 520 connected, the present disclosure is not limited thereto and may be used to connect in this way more than two trap modules similar to trap modules 510 and 520.

In FIG. 5, the trap modules 510 and 520 also comprise conductive connection portion 540 and 550 respectively. The connection portions 540 and 550 serve for connecting the respective trap module 510 and 520 to an external module 560. As mentioned with reference to FIG. 4, the external module may be a socket (or plug) or a chip substrate or a chip adapted to accommodate a trap or a trap module, or the like. The connection portions 540 and 550 may correspond to a spring or a part applying pressure to the spring as discussed with reference to FIGS. 1(a)-(c) and 2(a)-(c).

FIG. 6 illustrates schematically a trap assembly 600 comprising a trap module 620 and an external module 670 connected together mechanically by mechanical connection means 650 and connected together electrically by the connection portion 640 corresponding to a spring or a part applying pressure to the spring as discussed with reference to FIGS. 1(a)-(c) and 2(a)-(c) (the spring may be on the trap module 620 and the part applying pressure on the spring may be on the external module 670). The mechanical connection 650 causes the electrical connection because it causes pressure to be applied on the spring. The mechanical connection may be permanent or attachable as well as detachable. For example, the mechanical connection 650 may be clamps stacking and pressing together the trap module 620 and the external module 670. However, the presently disclosed subject matter is not limited thereto. Some further exemplary means for mechanic connection comprise screws, adhesive (e.g., glue) applied between the trap module and the external module; snapping mechanism formed from the bulk on the trap and/or the external module; and/or the like.

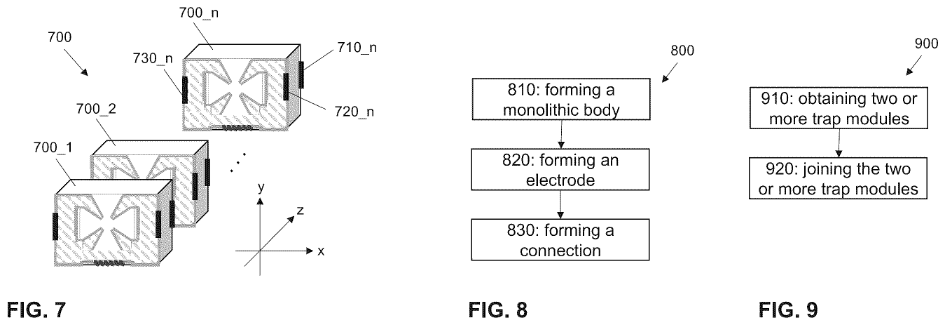

FIG. 7 shows schematically a non-limiting example of a trap assembly 700 cascading of n trap modules 700_1 to 700_n. Each of the trap modules 700_1 to 700_n may have a construction as discussed above with reference to FIGS. 1 and 2. As shown for the trap module 700_n, each of these modules may comprise a plug connection portion 720_n including a spring (such as 110, 210) and a socket connection portion 710_n adapted to apply pressure on the plug connection portion 710_n when connected. Similar portions are schematically shown in the remaining trap modules 700_1, 700_2, . . . , 700_(n−1). It is noted that two cascaded trap modules may be connected by more than one connection portions at the same time. For example, each trap module i may have a connection portion 710_i and 730_i via which the two are connected. Both of them may be of the same kind (plug or socket) or one may be of a plug type while the other one may be of a socket type.

FIG. 7 shows an example, in which the trap modules 700_i with i=710_1 to 710_n are cascaded in the z axis direction. In this way, the trap modules are stacked along the axis along which the trapping zone is extending. Thus, stacking more trap modules facilitates extending the length of the trapping zone.

However, the present disclosure is not limited thereto. In addition or alternatively, the trap modules may be cascaded in the x axis direction or in the y axis direction (orthogonal on the z axis direction). Such stacking is exemplified for two trap modules in FIG. 5. Such arrangement may facilitate forming of parallel trapping zones.

FIG. 8 is a flow diagram of a non-limiting example of a method 800 for manufacturing a module of a trap. The method 800 comprises a step 810 of forming a monolithic body (e.g., 150, 160, 410, 420, 510, 520, 620, 700_1-700_n) out of a non-conductive substrate including forming a spring element (e.g., 110, 210) in a part of the monolithic body adapted to be compressed upon pressure applied on a first spring area. The method 800 further comprises a step 820 forming an electrode covering a portion of a surface of the monolithic body (e.g., 381, 382, 390) and the first spring area (e.g., 145). The method 800 further comprises a step 830 forming an electrical connection between the electrode and the first spring area (e.g., 145).

It is noted that step 830 does not necessarily need to be a separate production step. For example, the conductive layer of the electrode and/or the first spring area may be continued to form the electrical connection, so that it can be produced in a one production step.

For example, the monolithic body is formed 810 via selective laser etching, SLE; laser milling; ion beam milling; or by additive manufacturing. Materials mentioned above may be used with these techniques.

For example, said forming 820 an electrode covering a portion of a surface of the monolithic body and the first spring area are performed by coating a metal based material (e.g., as mentioned above: gold, niobium, silver aluminum or the like). It is noted that the step 830 of forming connection between the electrode and the first spring area may be part of step 820 and the connection may be coated on the surface of the monolithic body. In general, any of the known metal coating approaches may be used, such as physical vapor deposition, electroplating, sputtering, e-beam evaporation, or the like.

However, the present disclosure is not limited to connection between an electrode and the first spring area coated on the surface of the monolithic body. The connection may lead through the monolithic body as through via. It may be performed as a part of forming 810 the monolithic body. The manufacturing in an exemplary implementation includes forming the spring as a cantilever as described above with reference to FIGS. 1(a)-(c) or 2(a)-(c).

FIG. 9 illustrates a non-limiting example of a method 900 for manufacturing an ion trap. The method 900 comprises mechanically joining a plurality of modules of the trap (such as the one described in any of examples above) in a cascade (one following other, i.e. one connected to another). For each two adjacent modules, a first module (e.g., 410, 510, 700_k) and a second module (e.g., 420, 520, 700_ (k+1)) are connected in the cascade, and a pressure element of a first module of the ion trap conductively connects with the spring element of a second module of the ion trap. Herein, k is an integer from 1 to n-1.

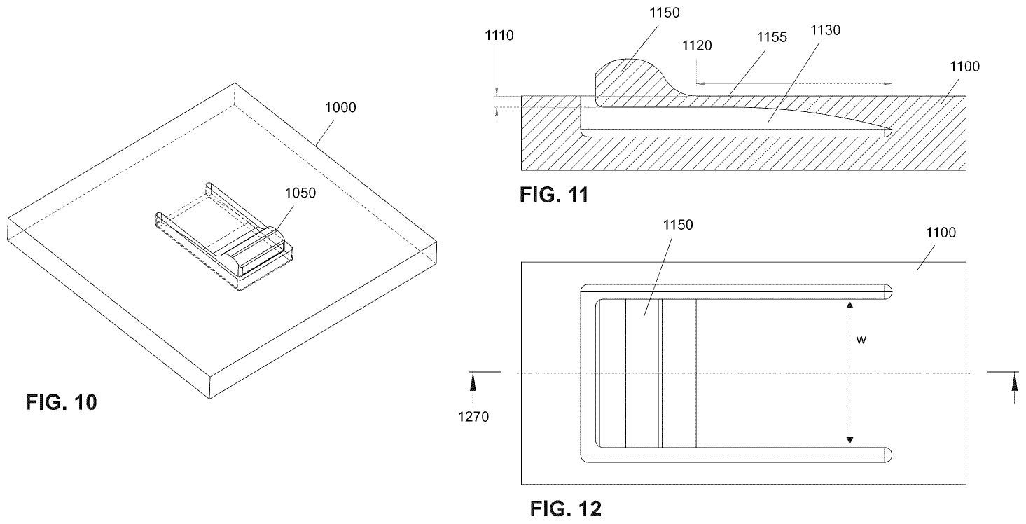

In FIGS. 1(a)-(c) and 2(a)-(c), the spring side view cross-section has been schematically illustrated. FIG. 10 shows an example oblique view of a non-limiting example of a possible exemplary implementation of a cantilever spring. For example, the cantilever spring 1050 is formed on a flat surface portion 1000 made of the same monolithic material. A force range applicable to such a spring may be 0.01-1 N. As can be seen in FIG. 10, the spring 1050 has a slightly different shape from the springs illustrated in FIGS. 1 and 2.

For example, as shown in FIG. 11, the monolithic material 1100 forms a spring (1150, 1155) over a recess 1130. The spring has an end portion 1150 that bulging over a (substantially) flat portion 1155 of the spring. It may be the bulging end portion 1150 that is used to form connection with another trap module or an external module by being compressed towards the recess 1130. The entire spring including both portions 1150 and 1155 may be metal-coated as already mentioned above with reference to FIGS. 1 and 2. Some design parameters to be considered when designing the spring are the thickness 1110 of the spring and the length of the compressible cantilever portion 1155. These design parameters may be found based on the desired size of the spring, based on the monolithic material, based on the metal coating on the top of the spring (at least the compressible portion 1155), based on the desired force to be applied by the spring when compressed, or the like. Some exemplary and non-limiting exemplary values have been provided above.

FIG. 12 shows a top view of the spring shown in FIGS. 10 and 11. The monolithic material 1100 forms the spring with the connecting end portion 1150. Line 1270 illustrates the line along which the cross-section of FIG. 11 is represented.

In the top view, the spring has a substantially rectangular shape. It is notes that width w of the spring shown in FIG. 12 is only exemplary. In general, the ratio between the width w and the length 1155 (possibly plus the end portion 1150) may be different (larger or smaller).

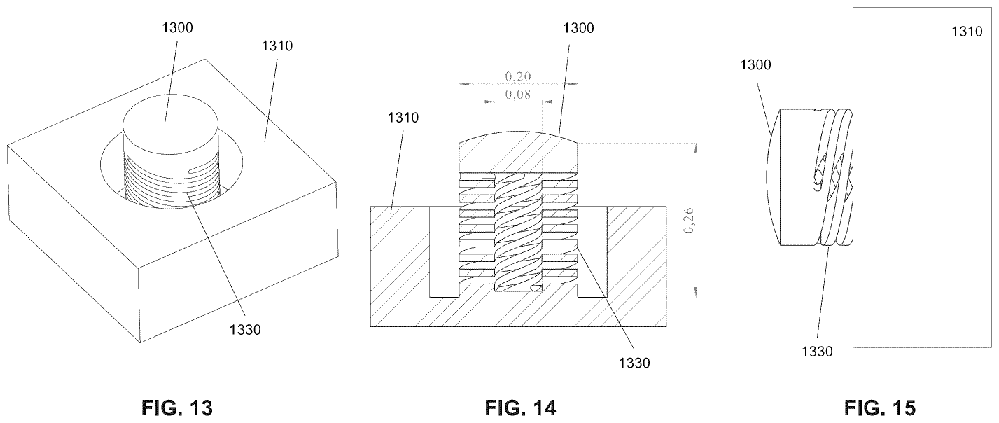

Although a cantilever spring form may provide for a simple construction, the spring may have various different shapes. FIGS. 13-15 illustrate another non-limiting example of a spring having a helical shape.

FIG. 13 shows an oblique (3D) view of a helix spring 1330 that is formed from the monolithic material 1310 of the trap module and an end portion 1300 of the spring that may be metalized and that would be a conducting (contact) portion corresponding to the spring part 145 of FIG. 1 in function. By exercising pressure on the contact portion 1300, the spring 1330 would compress.

FIG. 14 shows a cross-section of the helical spring including four nested helices with two windings per helix. This construction offers an advantage that the footprint is smaller at a similar spring constant and maximum travel distance compared to a cantilever. Such 4-helical spring may be manufactured by any available process, e.g., comprising selective laser etching (SLE) or by additive manufacturing (such as 3D printing).

FIG. 15 shows a side view of the spring 1330. It is noted that the contact portion 1300 in this example is shown as rounded with a maximum height in the middle. However, this is only example and the contact portion 1300 may be flat or have another shape. The rounding may provide an improved conductive connection.

FIG. 14 also shows exemplary measures of the spring 1330 that are only for illustration and not to limit the present disclosure. For instance, the width of the spring is 0.20 mm, the height of the spring (not compressed) is 0.26 mm up to the base of the contact portion 1300. The thickness of the outer helix is 0.20 mm. The width of the inner cut-out is 0.08 mm. A force range applicable to such a spring may be 0.01-1N.

In summary, in some non-limiting embodiments the present disclosure provides approaches for realizing one or more electrical connections to an electrical interface outside of a trap or between different parts of a trap by:
Creating a mechanical spring (e.g., 110, 210), that is located on the contact surface (e.g., 151, 152) between parts (e.g., 410, 420) of a trap (e.g., 400) or on the contact surface to an interface outside the trap (e.g., 470). This spring is formed monolithically from the same non-conductive bulk material the trap 400 is made from. The thickness and shape of the spring is to be adjusted to the elasticity and other material properties of the bulk material. The spring (e.g., 110 or 210) can either protrude (132) out of the contact surface (151) or be recessed (231) in the bulk (250) if the opposing structure (270) is protruded (275).
Metalizing the surface of the resulting monolithic structure to create a conductive surface which at the same time is creating and defining the electrodes (e.g., 381, 382, 390) of the trap and establishes an electrically conductive connection to the contact surfaces of the springs.
Mounting and connecting the trap to an electrical interface (e.g., 460, 470, 540, 550, and 640) outside of the trap or mechanically connecting (e.g., 650) the parts of the trap by physically merging their respective contact surfaces. In this way, the mechanical springs are compressed and an electrical contact with the respective electrode on the other side is established. Thus, electrical contact between the electrodes of a trap or a part of a trap can be made to an electrical interface outside of the trap or to the electrodes of another part of the trap, respectively.

The manufacturing or structuring of the mechanical spring within the bulk material can be done via mechanical machining or milling, selective laser etching (SLE), lithographic methods, focused ion beam milling, or additive manufacturing methods such as 3D printing. However, the present disclosure is not limited to these particular manufacturing steps. A mechanical spring is formed from the same non-conductive bulk material that supports the electrode structure of a trap. Thus, a separate part or process that establishes the electrical connection is not required. Machining or forming the spring contact can be performed by the very same method or process that is used to produce the shape of the trap itself.

The present disclosure is applicable to ion traps, Paul traps, ion traps that are made from a non-conductive bulk material, which is metallized to form and define the spatial structure of the electrodes of the trap. For example, SLE manufacturing based on fused silica as bulk material may be applied.

For example, an ion trap module includes a spring that is monolithically formed in the non-conductive substrate material. Conducting electrode material is coated to substrate surface conductively connected with electrode of the bulk. Some useful monolithic material properties comprise UHV compatibility, low RF-loss, being bakeable, or the like. Some further desirable features comprise thermal conductivity and/or a low coefficient of expansion.

Some suitable materials comprise glass (fused silica), sapphire, diamond, silicon, and/or ceramic, or the like. The spring contact leads to an ion trap electrode. At least one spring and at least one ion trap electrode are formed from the same monolithic bulk material. In a non-limiting example, the monolithic structure is formed via SLE. In another non-limiting example, the monolithic structure is formed via additive manufacturing.

According to a first non-limiting aspect, a module of an ion trap (or in general a trap for charged particles) is provided. The module comprises a monolithic body made of a non-conductive substrate and an electrode arranged on a portion of a surface of the monolithic body. A part of the monolithic body forms a spring element. An electrically conductive area is arranged on and covers a portion of a surface of the spring element and is conductively connected with the electrode. The spring element is adapted to compress upon pressure applied on the electrically conductive area.

According to a second non-limiting aspect, in addition to the first aspect, the spring element is a cantilever formed by extending a portion of the surface of the monolithic body over a surface of the monolithic body.

According to a third non-limiting aspect, in addition to the second aspect, the cantilever extends over a recess of the surface of the monolithic body.

According to a fourth non-limiting aspect, in addition to any of the first aspect to third aspect, the spring element protrudes from a flat surface of the monolithic body in which the spring element is formed and is adapted to reduce the protrusion upon the pressure is applied to the electrically conductive area.

According to a fifth non-limiting aspect, in addition to any of the first aspect to the fourth aspect, the electrically conductive area is located on an outer surface of the spring element facing away from the module of an ion trap.

According to a sixth non-limiting aspect, in addition to any of the first aspect to fifth aspect, the non-conductive substrate is made of glass, fused silica, sapphire, diamond, silicon, and/or ceramic.

According to a seventh non-limiting aspect, in addition to any of the first aspect to sixth aspect, the module of an ion trap is a Paul trap module including an arrangement or a part of the arrangement of direct current, DC, and radio frequency, RF, electrodes for trapping of charged particles.

According to an eighth non-limiting aspect, in addition to any of the first aspect to seventh aspect, the module of an ion trap further comprises a pressure element with an electrically conducting surface and conductively connected to the electrode, wherein the module of an ion trap is a first module of the ion trap and is adapted to be mechanically joined with a second module of the ion trap according to any of the first aspect to sixth aspect, thereby, the pressure element of the first module of the ion trap conductively connecting with the spring element of the second module of the ion trap.

According to a ninth non-limiting aspect, an ion trap (or in general a trap for charged particles) is provided, the ion trap comprising a first module of the ion trap that is the module according to any of the first aspect to eighth aspect, and a second module of the ion trap adapted to be mechanically joined with the first module of the ion trap. The second module comprises: (i) an electrode on arranged on and covering a portion of a surface of the second ion trap module; and (ii) a pressure element with an electrically conducting surface and conductively connected to the electrode. The first module of the ion trap and the second module of the ion trap are mechanically joined and, thereby, the pressure element of the second module of the ion trap applies pressure on the electrically conductive area of the first module of the ion trap.

According to a tenth non-limiting aspect, an ion trap (or in general a trap for charged particles) assembly is provided, comprising the module of an ion trap according to any of the first aspect to the ninth aspect. The ion trap assembly further comprises a chip carrier or a socket for mounting the module of an ion trap, adapted to be mechanically joined with the module of an ion trap and comprising a pressure element with an electrically conducting surface. The module of an ion trap and the chip carrier or a socket are mechanically joined and, thereby, the pressure element applies pressure on the electrically conductive area of the module of an ion trap.

According to an eleventh non-limiting aspect, a method is provided for manufacturing a module of an ion trap (or in general a trap for charged particles). The method comprises (i) forming a monolithic body out of a non-conductive substrate including forming a spring element in a part of the monolithic body adapted to be compressed upon pressure applied on a first spring area, (ii) forming an electrode covering a portion of a surface of the monolithic body and the first spring area, and (iii) forming an electrical connection between the electrode and the first spring area.

According to a twelfth non-limiting aspect, in addition to the eleventh aspect, the monolithic body is formed via selective laser etching, SLE, laser milling, ion beam milling, and/or by additive manufacturing.

According to a thirteenth non-limiting aspect, in addition to the eleventh aspect or the twelfth aspect, said forming an electrode covering a portion of a surface of the monolithic body and the first spring area are performed by coating.

According to a fourteenth non-limiting aspect, a method is provided for manufacturing an ion trap (or in general a trap for charged particles) comprising mechanically joining a plurality of modules of the ion trap according to the eighth aspect in a cascade, wherein for each two adjacent modules, a first module and a second module, in the cascade, a pressure element of a first module of the ion trap conductively connects with the spring element of a second module of the ion trap.

1. A module of a trap for charged particles, comprising:
a monolithic body made of a non-conductive substrate; and
an electrode arranged on and covering a portion of a surface of the monolithic body;
wherein:
a part of the monolithic body forms a spring element,
an electrically conductive area is arranged on and covers a portion of a surface of the spring element and is conductively connected with the electrode, and
the spring element is adapted to compress upon pressure applied on the electrically conductive area.

2. The module of a trap for charged particles according to claim 1, wherein the spring element is a cantilever formed by extending a portion of the surface of the monolithic body over a surface of the monolithic body.

3. The module of a trap for charged particles according to claim 2, wherein the cantilever extends over a recess of the surface of the monolithic body.

4. The module of a trap for charged particles according to claim 1, wherein the spring element has a form of a helix.

5. The module of a trap for charged particles according to claim 1, wherein the spring element protrudes from a flat surface of the monolithic body in which the spring element is formed and is adapted to reduce the protrusion upon the pressure is applied to the electrically conductive area.

6. The module of a trap for charged particles according to claim 1, wherein the electrically conductive area is located on an outer surface of the spring element facing away from the module of a trap.

7. The module of a trap for charged particles according to claim 1, wherein the non-conductive substrate is made of glass, fused silica, sapphire, diamond, silicon, and/or ceramic.

8. The module of a trap for charged particles according to claim 1, wherein the module of a trap is a Paul trap module including an arrangement or a part of the arrangement of direct current (DC) and radio frequency (RF) electrodes for trapping of charged particles.

9. The module of a trap for charged particles according to claim 1, further comprising:
a pressure element with an electrically conducting surface and conductively connected to the electrode,
wherein the module of a trap is a first module of the trap and is adapted to be mechanically joined with a second module of the trap, thereby, the pressure element of the first module of the trap conductively connecting with a spring element of the second module of the trap.

10. A trap for charged particles, comprising:
a first module of the trap that is the module according to claim 1, and
a second module of the trap adapted to be mechanically joined with the first module of the trap and comprising:
an electrode arranged on and covering a portion of a surface of the second trap module; and
a pressure element with an electrically conducting surface and conductively connected to the electrode,
wherein the first module of the trap and the second module of the trap are mechanically joined and, thereby, the pressure element of the second module of the trap applies pressure on the electrically conductive area of the first module of the trap.

11. A trap assembly for charged particles, comprising:
the module of a trap for charged particles according to claim 1, and
a chip carrier or a socket for mounting the module of a trap, adapted to be mechanically joined with the module of a trap and comprising a pressure element with an electrically conducting surface, wherein
the module of a trap and the chip carrier or a socket are mechanically joined and, thereby, the pressure element applies pressure on the electrically conductive area of the module of a trap.

12. A method for manufacturing a module of a trap for charged particles, comprising:
forming a monolithic body out of a non-conductive substrate including forming a spring element in a part of the monolithic body adapted to be compressed upon pressure applied on a first spring area,
forming an electrode covering a portion of a surface of the monolithic body and the first spring area and,
forming an electrical connection between the electrode and the first spring area.

13. The method for manufacturing a module of a trap for charged particles according to claim 12, wherein the monolithic body is formed via selective laser etching (SLE) laser milling, ion beam milling, and/or by additive manufacturing.

14. The method for manufacturing a module of a trap for charged particles according to claim 12, wherein said forming an electrode covering a portion of a surface of the monolithic body and the first spring area is performed by coating.

15. A method for manufacturing a trap for charged particles comprising:
mechanically joining a plurality of modules of the trap according to claim 9 in a cascade, wherein for each two adjacent modules, a first module and a second module, in the cascade, a pressure element of a first module of the trap conductively connects with the spring element of a second module of the trap.
